(19) United States
(12) Patent Application Publication
(10) Pub. No.: US 2024/0380070 A1
(43) Pub. Date: Nov. 14, 2024

(54) BATTERY PACK AND DEVICE INCLUDING THE SAME

(71) Applicant: LG ENERGY SOLUTION, LTD., Seoul (KR)

(72) Inventors: Moon Youl AHN, Daejeon (KR); Soo Han KIM, Daejeon (KR)

(73) Assignee: LG ENERGY SOLUTION, LTD., Seoul (KR)

(21) Appl. No.: 18/692,009

(22) PCT Filed: Oct. 26, 2022
(86) PCT No.: PCT/KR2022/016489

§ 371 Date: Mar. 14, 2024

(30) Foreign Application Priority Data
Nov. 3, 2021 (KR) 10-2021-0149627

(51) Int. Cl. H01M 50/383; H01M 50/204; H01M 50/342; H01M 50/358

(52) U.S. Cl. CPC H01M 50/383; H01M 50/204; H01M 50/3425; H01M 50/358

(57) ABSTRACT

A battery pack includes a battery module including a plurality of battery cells, and a pack frame that houses the battery module. A venting flow path for discharging gas generated from the battery module is provided between the battery module and the pack frame. A filter mesh is formed on a lower surface of the venting flow path.

### TECHNICAL FIELD

### CROSS CITATION WITH RELATED APPLICATION(S)

This application claims the benefit of Korean Patent Application No. 10-2021-0149627 filed on Nov. 3, 2021 with the Korean Intellectual Property Office, the entire contents of which are incorporated herein by reference.

The present disclosure relates to a battery pack and a device including the same, and more particularly, to a battery pack that can prevent external ignition phenomena, and a device including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, the demand for development of the secondary battery is growing.

Currently commercialized secondary batteries include a nickel cadmium battery, a nickel hydrogen battery, a nickel zinc battery, and a lithium secondary battery. Among them, the lithium secondary battery has come into the spotlight because they have advantages, for example, being freely charged and discharged, and having very low self-discharge rate and high energy density.

Meanwhile, in the case of a secondary battery used for small-sized devices, two to three battery cells are used, but in the case of a secondary battery used for a middle or large-sized device such as an automobile, a battery module or a battery pack in which a large number of battery cells are electrically connected is used.

FIG. 1 shows a state before and after an ignition phenomenon of a mesh formed in a conventional battery pack.

Battery cells mounted in battery modules or battery packs can generate a large amount of heat in a charge and discharge process. If the temperature becomes higher than the proper temperature due to reasons such as overcharging, performance may deteriorate, and if the temperature rise is excessive, it may cause explosion or ignition. When the battery cell ignites, internal materials of the cell may be ejected along with high-temperature inflammable gas to the outside of the battery module or the battery pack. Such internal materials are mainly materials such as C, Cu, Al, Ni, Co, Mg, and Li, and are ejected in the form of high-temperature particles, that is, sparks.

Meanwhile, such sparks not only can promote continuous thermal runaway phenomena within the battery module or the battery pack, but also when discharged to the outside, it causes problems of the external ignition phenomena due to contact with a flammable gas or an external oxygen. Therefore, in recent years, attempts have been made to form a mesh on a frame of a battery module or battery pack to minimize the release of particles

However, even if a mesh is formed in the frame, when a particle closes an opening in the mesh as shown in FIG. 1, the release of internal gas is limited, and thus, the internal pressure of the battery module or pack increases rapidly, which causes problems of the explosion or damage to the frame. Therefore, there is a need for an effective frame structure that limits the release of sparks to the outside of the frame.

### DETAILED DESCRIPTION OF THE INVENTION

### Technical Problem

It is an object of the present disclosure to provide a battery pack having improved durability and safety by preventing external ignition phenomena caused by sparks, and a device including the same.

However, the problem to be solved by embodiments of the present disclosure is not limited to the above-described problems, and can be variously expanded within the scope of the technical idea included in the present disclosure.

### Technical Solution

According to one embodiment of the present disclosure, there is provided a battery pack comprising: a battery module including a plurality of battery cells, and a pack frame that houses the battery module, a venting flow path for discharging gas generated from the battery module between the battery module and the pack frame, and a filter mesh on a lower surface of the venting flow path.

The filter mesh may be parallel to a lower surface of the pack frame.

The venting flow path may be spaced apart from a lower surface of the pack frame.

A vent is formed on a first surface of the battery module, and the first surface faces the venting flow path.

A vent is formed on a first surface of the battery module, and one surface of the pack frame and the vent face each other.

The venting flow path may be located above the vent.

The filter mesh may be located above the vent.

The vent may be a plate that is broken above a predetermined pressure.

The venting part may be in the form of a valve that is opened at a predetermined pressure or higher.

According to another embodiment of the present disclosure, there is provided a device comprising at least one battery pack as described above.

### Advantageous Effects

According to embodiments, the battery pack of the present disclosure prevents particles from being releases to the outside of the battery pack, thereby preventing ignition phenomena from being propagated to the outside of the battery pack.

The effects of the present disclosure are not limited to the effects mentioned above and additional other effects not described above will be clearly understood from the detailed description and the appended drawings by those skilled in the art.

### BRIEF DESCRIPTION OF THE DRAWINGS

FIG. 1 shows a state before and after an ignition phenomenon of a mesh formed in a conventional battery pack;

FIG. 2 is a perspective view of a battery pack according to an embodiment of the present disclosure;

FIG. 3 is a perspective view of a battery module included in the battery pack according to FIG. 2;

FIG. 4 is a top view of the battery pack according to FIG. 2;

FIG. 5 is a partial cross-sectional view of the battery pack according to FIG. 2;

FIG. 6 is a schematic view of a first embodiment of the venting path; and

FIG. 7 is a schematic view of a second embodiment of the venting path.

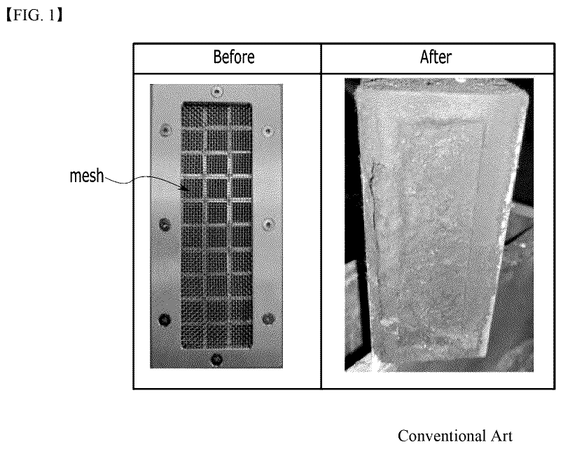

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means arranged on or below a reference portion, and does not necessarily mean being arranged on the upper end of the reference portion toward the opposite direction of gravity. Meanwhile, similarly to the case where it is described as being located “on” or “above” another part, the case where it is described as being located “below” or “under” another part will also be understood with reference to the above-mentioned contents.

Further, the upper surface/lower surface of a specific member can be determined differently depending on which direction is used for a reference direction. Thus, throughout the description, ‘upper surface’ or ‘lower surface’ is defined as meaning two surfaces facing each other on the z-axis of the member. In addition, the side surface may mean a surface that is perpendicular to the upper surface or the lower surface.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

Hereinafter, a battery pack according to one embodiment of the present disclosure will be described.

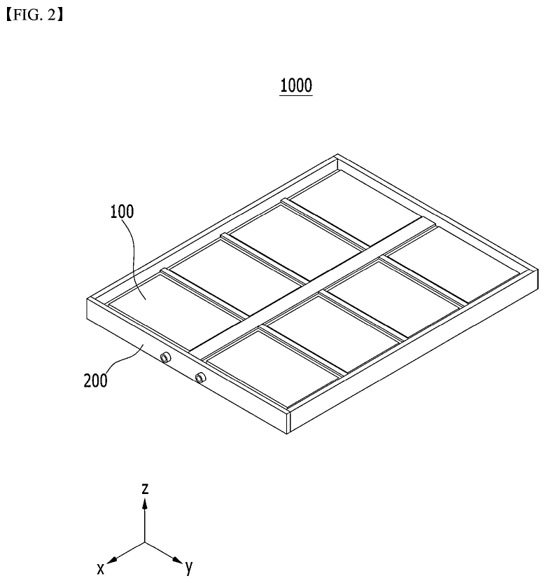

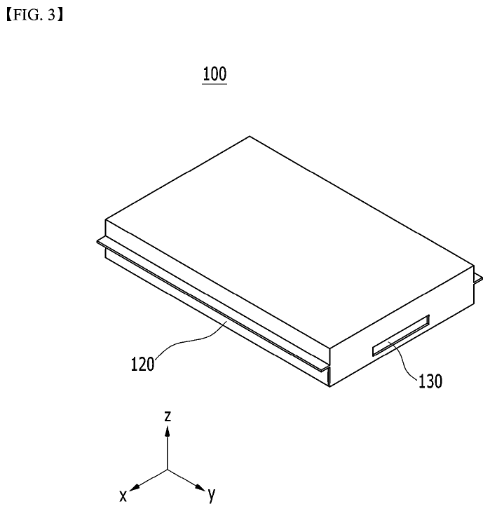

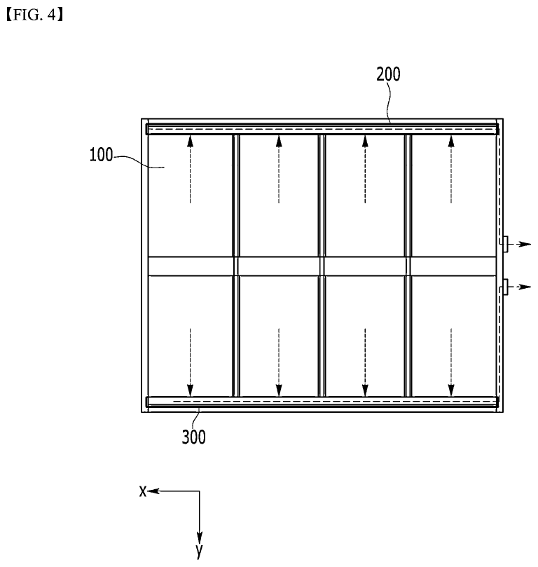

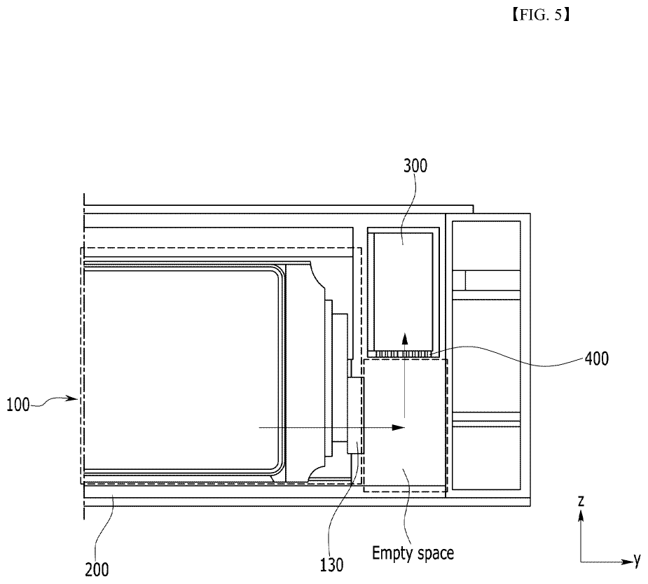

FIG. 2 is a perspective view of a battery pack according to an embodiment of the present disclosure. FIG. 3 is a perspective view of a battery module included in the battery pack according to FIG. 2. FIG. 4 is a top view of the battery pack according to FIG. 2. FIG. 5 is a partial cross-sectional view of the battery pack according to FIG. 2.

Referring to FIGS. 2 to 5, a battery pack 1000 according to one embodiment of the present disclosure includes at least one battery module 100, a pack frame 200 that houses the at least one battery module 100, and a venting flow path 300 formed between the battery module 100 and the pack frame 200.

The battery module 100 according to the present embodiment may include a battery cell stack in which a plurality of battery cells are stacked, a module frame 120 that houses the battery cell stack, a busbar frame that is located on the front surface and/or rear surface of the battery cell stack, a busbar and/or a sensing unit mounted on the busbar frame, and the like. However, the components included in the battery module 100 are not limited thereto, and depending on the design, the battery module 100 may be provided in the state of omitting some of the above-mentioned components, and may be provided in the state of adding other components not mentioned herein. The type of battery cells included in the battery module 100 is not particularly limited, and pouch-type, prismatic, or jelly-roll type cylindrical battery cells can all be applied.

The module frame 120 may include a metal having high thermal conductivity. Examples of the metal may be aluminum, gold, silver, copper, platinum or an alloy containing these. As the thermal conductivity of the metal is higher, the heat dissipation effect by the module frame improves, so that no specific range for thermal conductivity values is set.

Meanwhile, a venting part 130 may be located on one surface of the module frame 120. When the battery module 100 ignites, the venting part 130 can be for discharging gas, sparks, flame, or the like inside the module frame 120. The venting part 130 may be located on the lower part of one surface of the module frame 120. One surface of the module frame 120 on which the venting part 130 is formed may be a surface facing the electrode leads of the battery cell stack, the busbar frame, or the busbar.

The shape of the venting part 130 may be varied, and for example, it may be an opening shape. As another example, the venting part 130 may be in the form of a plate that is broken at a predetermined pressure or higher, such as a rupture disc. As yet another example, it may be in the form of a valve that can be opened at a predetermined pressure or higher, such as a relief valve.

As shown in FIGS. 2 and 4, a plurality of battery modules 100 may be provided in the battery pack 1000. The plurality of battery modules 100 may be arranged in rows and columns within the pack frame 200.

The pack frame 200 according to the present embodiment can be for protecting the battery module 100 and electrical components connected thereto from external physical impact. The pack frame 200 may include a lower frame including a lower surface (bottom surface) and a side surface. The battery modules 100 are arranged in the inner space of the lower frame formed from the lower surface and the side surface, and then the upper plate or upper frame is coupled with the edge of the lower frame, thereby capable of sealing the pack frame 200. Here, the upper plate or upper frame may be interpreted as being included in the pack frame 200, but this is not necessarily the case.

The pack frame 200 may include a portion having high thermal conductivity in order to quickly dissipate heat generated in the internal space to the outside. For example, at least a portion of the pack frame 200 may be made of a metal having high thermal conductivity, and examples thereof may be aluminum, gold, silver, copper, platinum, an alloy containing these, or the like. Moreover, the pack frame 200 may partially have electrical insulation, and an insulating film may be provided at a position where insulation is required, or an insulating coating may be applied. A portion of the pack frame 200 to which an insulating film or an insulating coating is applied may be referred to as an insulating portion.

The venting flow path 300 may be for discharging gas generated from the battery module 100 to the outside of the pack frame 200. As the venting flow path 300 restricts the venting path of gas, it is possible to minimize the influence of the high-temperature gas and the like discharged from the battery module 100 on the adjacent battery module 100. The venting flow path 300 may be formed in a separation space between the battery module 100 and the pack frame 200. Flames, gases, and the like discharged from each battery module 100 to the venting flow path 300 move along the venting flow path 300, so that it can be discharged to the outside through a discharge port provided in the pack frame 200.

The venting flow path 300 may be preferably formed so as to correspond to all battery modules 100 within the battery pack 1000. For example, as shown in FIG. 4, when the battery modules 100 are arranged in 2 rows and 4 columns, the venting flow path 300 can be formed between the battery modules 100 and the pack frame 200 arranged in each row. Flames, gases, and the like discharged from the battery module 100 may move along the dotted line arrow through the venting flow path 300 to discharged through the discharge port.

A venting part 130 may be located on one surface of the battery module 100 facing the venting flow path 300. The venting part 130 of the battery module 100 may be located toward the venting flow path 300. The battery module 100 may be arranged so that one surface on which the venting part 130 is formed faces the venting flow path 300. As shown in FIG. 4, when the venting flow path 300 is formed along the edge of the pack frame 200, the battery module 100 may be arranged so that the venting part 130 is located toward the pack frame 200. The venting flow path 300 may be formed extendedly along one surface of the pack frame 200 corresponding to the venting part 130.

Referring to FIG. 5, the venting flow path 300 is located so as to be spaced apart from the lower surface of the pack frame 200, and an empty space can be formed between the venting flow path 300 and the lower surface of the pack frame 200. The venting flow path 300 may be located on an upper side of the venting part 130 of the battery module 100. The venting part 130 is located so as to correspond to the empty space, and gas, flame, and the like discharged through the venting part 130 may be discharged into an empty space and then moved to the venting flow path 300 located on the upper side of the empty space.

A filter mesh 400 may be located in the venting flow path 300. The filter mesh 400 may be formed on a lower surface of the venting flow path 300. Gas and flame discharged from the battery module 100 into the empty space may move to the venting flow path 300 through the filter mesh 400.

The filter mesh 400 may be located parallel to the lower surface of the pack frame 200. When the filter mesh 400 is arranged parallel to the lower surface of the pack frame 200, the gas and flame discharged from the battery module 100 pass through the filter mesh 400 and move to the venting flow path 300, and the spark may not move through the filter mesh 400. When the release of high-temperature particles, that is, sparks, is restricted by the filter mesh 400, the possibility of the spark coming into contact with external oxygen is lowered, which can prevent further ignition.

The filter mesh 400 may be spaced apart from the lower surface of the pack frame 200. The filter mesh 400 may be located on an upper side of the venting part 130 of the battery module 100. When the filter mesh 400 is formed on the lower surface of the pack frame 200, particles may fall in the direction of gravity and close an opening in the filter mesh 400. However, the venting flow path 300 of the present embodiment is located on an upper side of the initial movement path of the gas discharged through the venting part 130, and gases and the like discharged from the battery module 100 may move in a direction opposite to gravity and move to the venting flow path 300 via the filter mesh 400. Therefore, particles and the like discharged from the battery module 100 and moved together with the gas can collide with the filter mesh 400 and then fall, thereby being able to prevent the filter mesh 400 from being blocked by particles or the like.

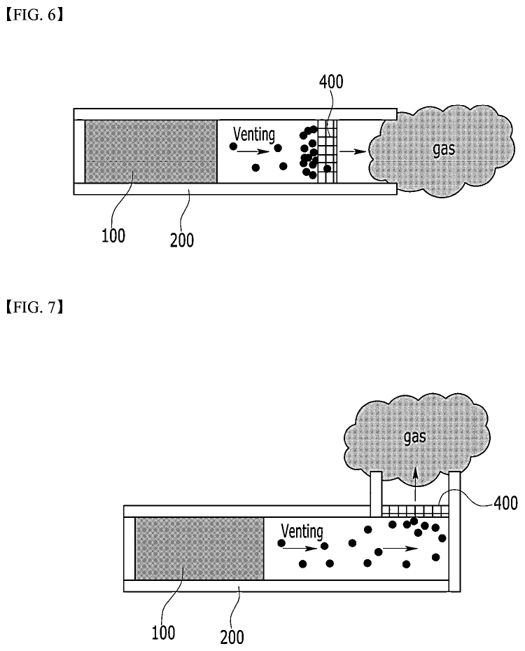

FIGS. 6 and 7 are diagrams for comparing effects according to positions of filters. FIG. 6 is an example in which the filter mesh 400 is formed perpendicular to the lower surface of the pack frame 200, and FIG. 7 is an example in which the filter mesh 400 is formed parallel to the lower surface of the pack frame 200.

Referring to FIGS. 6 and 7, the gas or the like discharged from the battery module 100 is moved through the filter mesh 400, and the particles may be restricted in movement by the filter mesh 400 and may not be discharged to the outside.

Since the filter mesh 400 of FIG. 6 is arranged perpendicular to the initial movement direction of the gas discharged from the battery module 100, particles discharged together with the gas can collide with the filter mesh 400 without changing the direction. The filter mesh 400 of FIG. 6 has the advantage of effectively collecting a large number of particles, whereas as time passes, the opening of the filter mesh 400 can be blocked by particles, which causes a problem that the gas discharge path is sealed. As the particle closes an opening in the filter mesh 400, internal gas discharge is limited. This, after a predetermined time has elapsed, the opening of the filter mesh 400 may be closed, and the internal pressure of the battery pack 1000 increases, which may cause collapse or explosion of the pack frame 200.

Meanwhile, since the filter mesh 400 of FIG. 7 is arranged parallel to the initial movement direction of the gas discharged from the battery module 100, particles discharged together with the gas may rise in a direction opposite to gravity and collide with the filter mesh 400. Therefore, when the filter mesh 400 is formed as shown in FIG. 7, the particle is unlikely to collide with the filter mesh 400, or even if it collides, it may lose energy and fall. The filter mesh 400 of FIG. 7 may be less likely to be blocked by particles than the filter mesh 400 of FIG. 6, which can minimize collapse or explosion problems of the pack frame 200 due to the closing of the filter mesh 400.

In addition, since the filter mesh 400 is provided in the form of FIG. 7, the filter mesh 400 can be densely formed to have smaller openings. When the filter mesh 400 is provided in the form of FIG. 6, it may be desirable to form with a slightly large opening to prevent closure, but when it is provided in the form of FIG. 7, such limitation is not necessary, which is thus advantageous for various designs.

Meanwhile, although not specifically mentioned above, the battery pack according to one embodiment of the present disclosure may further include a battery management system (BMS) and/or a cooling device that control and manage battery's temperature, voltage, etc.

The battery pack according to an embodiment of the present disclosure can be applied to various devices. For example, the device to which the battery pack is applied may be a vehicle means such as an electric bicycle, an electric vehicle, or a hybrid vehicle, but the above-mentioned device is not limited thereto, and the battery pack according to the present embodiment can be used for various devices in addition to the above illustrations, which also falls within the scope of the present disclosure.

Although preferred embodiments of the present disclosure have been described in detail above, the scope of the present disclosure is not limited thereto, and various modifications and improvements can be made by those skilled in the art using the basic concepts of the present disclosure which are defined in the appended claims, which also fall within the scope of the present disclosure.

### DESCRIPTION OF REFERENCE NUMERALS

1000: battery pack
100: battery module
200: pack frame
300: venting flow path
400: filter mesh

1. A battery pack comprising:
a battery module including a plurality of battery cells;
a pack frame that houses the battery module;
a venting flow path for discharging gas generated from the battery module between the battery module and the pack frame; and
a filter mesh on a lower surface of the venting flow path.

2. The battery pack according to claim 1, wherein the filter mesh is parallel to a lower surface of the pack frame.

3. The battery pack according to claim 1, wherein the venting flow path is spaced apart from a lower surface of the pack frame.

4. The battery pack according to claim 1, wherein a vent is formed on a first surface of the battery module, and the first surface faces the venting flow path.

5. The battery pack according to claim 1, wherein a vent is formed on a first surface of the battery module, and one surface of the pack frame and the vent face each other.

6. The battery pack according to claim 4, wherein the venting flow path is above the vent.

7. The battery pack according to claim 4, wherein the filter mesh is above the vent.

8. The battery pack according to claim 4, wherein the vent is a plate that is broken at a predetermined pressure or higher.

9. The battery pack according to claim 4, wherein the vent is a valve that is opened above a predetermined pressure.

10. A device comprising at least one battery pack as set forth in claim 1.
